(19) United States
(12) Patent Application Publication
(10) Pub. No.: US 2011/0106668 A1
(43) Pub. Date: May 5, 2011

(54) PAYMENT APPLICATION ON CLIENT DEVICE

(76) Inventors: Jason Korosec, San Jose, CA (US); Barak Turovsky, San Francisco, CA (US)

(21) Appl. No.: 12/608,288

(22) Filed: Oct. 29, 2009

(51) Int. Cl. G06Q 20/00; G06Q 30/00; G06Q 10/00; G06Q 50/00

(52) U.S. Cl. 705/30; 705/40; 705/34

(57) ABSTRACT

A payment method according to an embodiment comprises receiving, by a payment provider, a payment amount for an application, product and/or service selected by a user over a client device, wherein the payment amount is split between one or more receivers according to instructions provided for splitting the payment amount; and transferring the payment amount to one or more accounts among the one or more receivers according to the instructions.

### BACKGROUND

1. Technical Field

Embodiments of the present disclosure generally relate to financial transactions, and more particularly, to methods and systems for financial transactions conducted via a client device.

2. Related Art

In electronic commerce, a customer routinely searches for, purchases and pays for products and/or services from online merchants over communication networks, such as the Internet. In this regard, individual customers may frequently engage in transactions with a variety of merchants through, for example, various merchant websites. Routinely, customers engage in such transactions by using their mobile device. However, typical ways of making payments over the Internet may be cumbersome and inconvenient. For example, a common way of making payments over the Internet includes using a credit card. Use of a credit card may be inconvenient in that it requires, as an example, entering credit card information for each purpose, which may be especially cumbersome when using a mobile device. Accordingly, there is a need for a simple way of making payments over a network such as the Internet with minimal key entries.

### SUMMARY

As will be further described herein in relation to various embodiments, methods and systems for financial transactions conducted via a client device are provided, allowing a user to make payments for purchases and/or services in a simple way with minimal key entries.

In accordance with an embodiment of the disclosure, a payment method comprises receiving, by a payment provider, a payment amount for an application, product and/or service selected by a user over a client device, wherein the payment amount is split between one or more receivers according to instructions provided for splitting the payment amount; and transferring the payment amount to one or more accounts among the one or more receivers according to the instructions.

In accordance with another embodiment of the disclosure, a client device includes a payment application loaded in the client device from a service provider server; one or more processors; and one or more memories adapted to store a plurality of machine-readable instructions which when executed by the one or more processors are adapted to cause the client device to: cause the service provider server to receive a payment amount for a selected application, product and/or service over a network, wherein the payment amount is split between one or more receivers according to instructions provided to the service provider server; and wherein the payment amount is transferred, by the service provider server, to one or more accounts among the one or more receivers according to the instructions.

In accordance with another embodiment of the disclosure, a payment system comprises a client device adapted to communicate with a payment service provider over a network; one or more processors; and one or more memories adapted to store a plurality of machine-readable instructions which when executed by the one or more processors are adapted to cause the payment system to: receive, by the payment service provider, a payment for an application, product and/or service selected by a user over the client device, wherein the payment is split between one or more receivers according to instructions provided to the payment service provider over the network, causing a user's payment service provider account to be debited and causing each of the one or more receivers' payment service provider account(s) to be credited according to the instructions.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 is a block diagram of a payment system using a payment service provider according to an embodiment of the present disclosure.

FIG. 2 is a block diagram for making a one-time payment according to an embodiment of the present disclosure.

FIG. 3 is a block diagram for a billing agreement according to an embodiment of the present disclosure.

FIG. 4a is a flow diagram illustrating a chain split payment according to an embodiment of the present disclosure.

FIG. 4b is a flow diagram illustrating a parallel split payment according to an embodiment of the present disclosure.

FIG. 4c is a flow diagram illustrating a chain plus parallel split payment according to an embodiment of the present disclosure.

FIG. 4d is a flow diagram illustrating a parallel plus chain split payment according to an embodiment of the present disclosure.

FIG. 4e is a flow chart for effectuating payment instructions according to an embodiment of the present disclosure.

FIG. 5 is a block diagram of a system for implementing a device according to one embodiment of the present disclosure.

Like element numbers in different figures represent the same or similar elements.

### DETAILED DESCRIPTION

In accordance with various embodiments described herein, methods and systems are provided that enable a user to easily make payments for applications, products and/or services over a client device. A payment application, which may be loaded on a client device by a payment service provider, enables a user to easily make payments on a client device. The payment application may be provided by a payment service provider such as PayPal and/or eBay of San Jose, Calif.

According to one or more embodiments, payments may be made easily by a user over a client device by first entering credentials for authentication. Once authenticated, the user may select one or various options to effect a payment. In an embodiment, the user may use a quick payment option, which uses default information, such as a default funding source, to effect the payment. Alternatively, the user may skip the quick payment option and instead select, for example, a different funding source, which may virtually be any funding source in the world. In another embodiment, a user may set up a billing agreement, which may be done over the client device. In a billing agreement the user pre-authorizes an entity such as a merchant (or a partner that processes transactions on behalf of merchant(s)) to charge the available funding sources on the user's account with variable amounts every time the user makes a purchase without the need to log into the user's account to authorize each charge. The billing agreement enables the user to customize the agreement, for example, based on expiration date, number of transactions, dollar amount per transaction, etc. Once the billing agreement is created, the user may quickly and easily pay for an application, product and/or service, for example, by simply entering a PIN or other credential. In another embodiment, a user may set up a subscription/recurring agreement, which may be done over the client device. In subscription/recurring agreements a user pre-authorizes an entity such as a merchant (or a partner that processes transactions on behalf of merchant(s)) to charge a default funding source on the user's account with constant amounts in pre-defined frequency (monthly, weekly etc.), without the need to login to authorize each charge. In still other embodiments, the payment application may also split a user payment so that the payment is allocated to one or more parties, for example, to one or more of a phone manufacturer, the developer of the application, product and/or service, and the payment provider. Thus, a user may simply select to purchase an application, product and/or service, such as a video download, and quickly pay or exercise various payment options via the client device with minimal key entries.

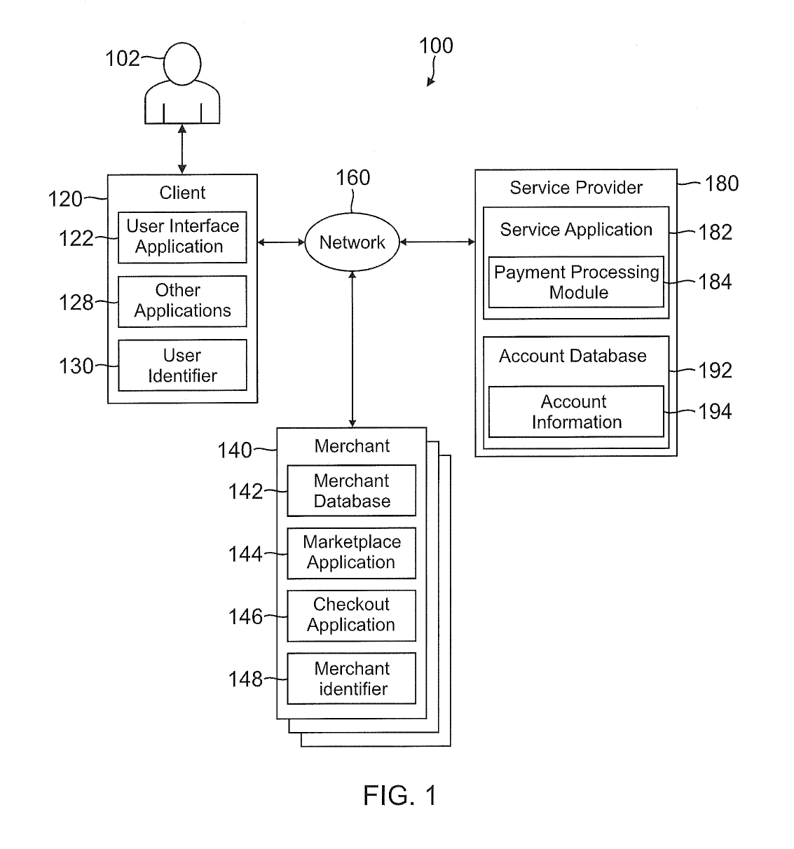

Referring now to the drawings wherein the showings are for purposes of illustrating embodiments of the present disclosure only, and not for purposes of limiting the same, FIG. 1 illustrates a block diagram of a payment system using a payment service provider according to an embodiment of the present disclosure.

FIG. 1 shows one embodiment of a block diagram of a system 100 adapted to facilitate user payment transactions via a client device 120 over a network 160. As shown in FIG. 1, the system 100 includes at least one client device 120 (e.g., network computing device), one or more merchant servers or devices 140 (e.g., network server devices), and at least one service provider server or device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the client device 120, merchant servers or devices 140, and service provider server or device 180 may be associated with a particular link (e.g., a link, such as a URL (Uniform Resource Locator) to an IP (Internet Protocol) address).

The client device 120, in various embodiments, may be implemented using any appropriate combination of hardware and/or software configured for wired and/or wireless communication over the network 160. In various examples, the client device 120 may be implemented as a wireless telephone (e.g., cellular or mobile phone), a personal digital assistant (PDA), a personal computer, a notebook computer, and/or various other generally known types of wired and/or wireless computing devices. Other examples of client device 120 include a television set, a game console, a Digital Video Recorder (DVR), and potentially other devices such as microwaves, refrigerators, washing machines, etc. It should be appreciated that the client device 120 may be referred to as a user device or a customer device without departing from the scope of the present disclosure.

The client device 120, in one embodiment, includes a user interface application 122, which may be utilized by the user 102 to conduct financial transactions (e.g., shopping, purchasing, bidding, etc.) with the service provider server 180 over the network 160. In one aspect, purchase expenses may be directly and/or automatically debited from an account related to the user 102 via the user interface application 122, in a manner as described herein.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, the user 102 is able to access merchant websites via the one or more merchant servers 140 to view and select applications, products, and/or services for purchase, and the user 102 is able to purchase applications, products, and/or services from the one or more merchant servers 140 via the service provider server 180. Accordingly, the user 102 may conduct financial transactions (e.g., purchase and provide payment for applications, products, and/or services) from the one or more merchant servers 140 via the service provider server 180.

The client device 120, in various embodiments, may include other applications 128 as may be desired in one or more embodiments of the present disclosure to provide additional features available to the user 102. In one example, such other applications 128 may include security applications for implementing client-side security features, programmatic client applications for interfacing with appropriate application programming interfaces (APIs) over the network 160, and/or various other types of generally known programs and/or software applications. In still other examples, the other applications 128 may interface with the user interface application 122 for improved efficiency and convenience.

According to one or more embodiments, the user interface application 122 or the other applications 128 include a payment application that may be loaded on client device 120 by service provider server 180. Such payment application enables user 102 to easily make payments for applications, products and/or services over client device 120 as will be described herein in further detail.

The client device 120, in one embodiment, may include at least one user identifier 130, which may be implemented, for example, as operating system registry entries, cookies associated with the user interface application 122, identifiers associated with hardware of the client device 120, or various other appropriate identifiers. The user identifier 130 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 130 may be passed with a user login request to the service provider server 180 via the network 160, and the user identifier 130 may be used by the service provider server 180 to associate the user 102 with a particular user account maintained by the service provider server 180, in a manner as described herein.

The one or more merchant servers 140, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various applications, products, and/or services for purchase and payment. In some embodiments, business entities may need registration of the user identity information as part of offering the items, products, and/or services to the user 102 over the network 160. As such, each of the one or more merchant servers 140 may include a merchant database 142 for identifying available applications, products, and/or services, which may be made available to the client device 120 for viewing and purchase by the user 102. It should be appreciated that although a user-merchant transaction is illustrated in this embodiment, the system may also be applicable to user-user, merchant-merchant and/or merchant-user transactions.

Each of the merchant servers 140, in one embodiment, may include a marketplace application 144, which may be configured to provide information over the network 160 to the user interface application 122 of the client device 120. For example, the user 102 may interact with the marketplace application 144 through the user interface application 122 over the network 160 to search and view various applications, products, and/or services available for purchase in the merchant database 142.

Each of the merchant servers 140, in one embodiment, may include a checkout application 146, which may be configured to facilitate online financial transactions (e.g., purchase transactions) by the user 102 of applications, products, and/or services identified by the marketplace application 144. As such, in one aspect, the checkout application 146 may be configured to accept payment information from the user 102 over the network 160 as described herein.

Each of the merchant servers 140, in one embodiment, may include at least one merchant identifier 148, which may be included as part of the one or more applications, products, and/or services made available for purchase so that, e.g., particular applications, products, and/or services are associated with particular merchants. In one implementation, the merchant identifier 148 may include one or more attributes and/or parameters related to the merchant, such as business and banking information. As described in greater detail herein, the user 102 may conduct financial transactions (e.g., selection, monitoring, purchasing, and/or providing payment for applications, products, and/or services) with each merchant server 140 via the service provider server 180 over the network 160.

The service provider server 180, in one embodiment, may be maintained by a transaction processing entity, which may provide processing for financial transactions and/or information transactions between the user 102 and one or more of the merchant servers 140. As such, the service provider server 180 includes a service application 182, which may be adapted to interact with each client device 120 and/or each merchant server 140 over the network 160 to facilitate the selection, purchase, and/or payment of applications, products, and/or services by the user 102 from one or more of the merchant servers 140. In one example, the service provider server 180 may be provided by PayPal, Inc. and/or eBay of San Jose, Calif., USA.

The service application 182, in one embodiment, utilizes a payment processing module 184 to process purchases and/or payments for financial transactions between the user 102 and each of the merchant servers 140. In one implementation, the payment processing module 184 assists with resolving financial transactions through validation, delivery, and settlement. As such, the service application 182 in conjunction with the payment processing module 184 settles indebtedness between the user 102 and each of the merchants 140, wherein accounts may be directly and/or automatically debited and/or credited of monetary funds in a manner as accepted by the banking industry and as described herein.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 140). For example, account information 194 may include private financial information of each user 102 and each merchant associated with the one or more merchant servers 140, such as one or more account numbers, passwords, credit card information, banking information, or other types of financial information, which may be used to facilitate financial transactions between the user 102 and the one or more merchants associated with the merchant servers 140. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and the user 102 may have credentials to authenticate or verify identity with the service provider server 180. User attributes may include personal information, banking information and/or funding sources as previously described. In various aspects, the user attributes may be passed to the service provider server 180 as part of a login, selection, purchase, and/or payment request, and the user attributes may be utilized by the service provider server 180 to associate the user 102 with one or more particular user accounts maintained by the service provider server 180.

The payment system described above with respect to the embodiment of FIG. 1 may be used to set up and facilitate payment options using a client device including one-time payments, billing agreements, subscription/recurring payments, and splitting payments. These options will be described in more detail herein.

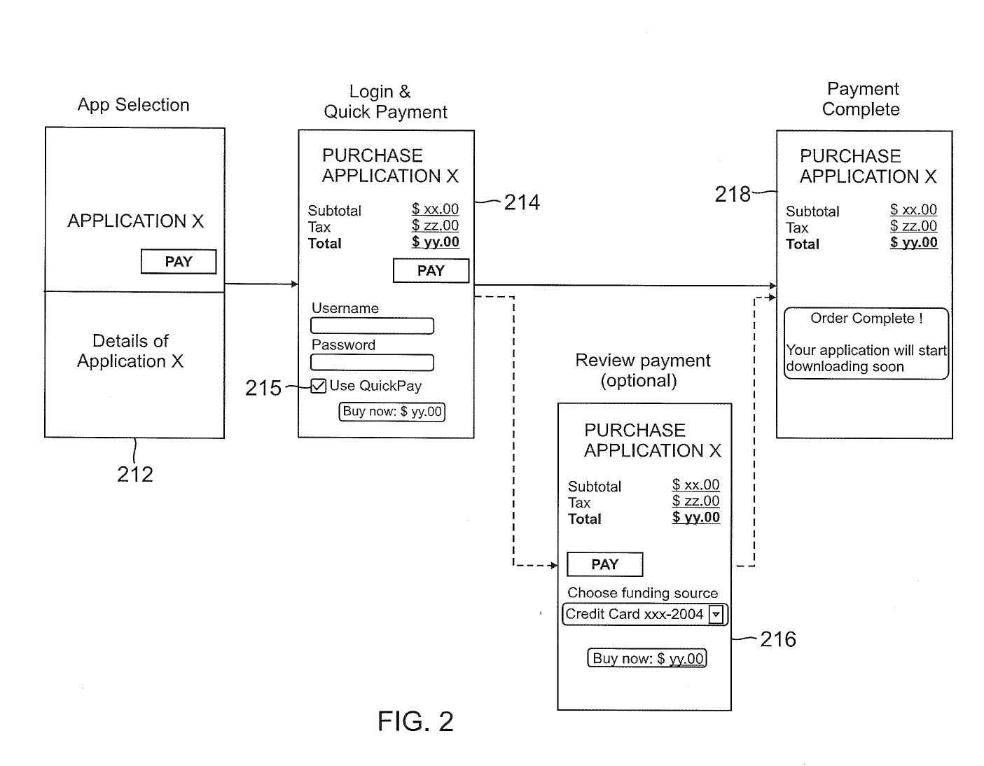

Referring now to FIG. 2, a block diagram for making a one-time payment using a client device is illustrated according to an embodiment of the present disclosure.

In block 212, when user 102 (referring also to FIG. 1) has a pre-existing account with service provider server 180 wherein user 102 has identity attributes stored with service provider server 180 as described above, user 102 may select to pay for an application, product and/or service using a one-time payment (or checkout) option. In the embodiment of FIG. 2, user 102 may browse merchant server 140 and decide to purchase a selected application, product and/or service, illustrated as Application X in FIG. 2.

In block 214, once user 102 decides to purchase and pay for the selected application, product and/or service, in this case, Application X, service provider server 180 may be used to effect a one time payment. A login screen is shown wherein user 102 may log in by entering, for example, a Username and Password to access his or her pre-existing account with service provider server 180 and may also choose to use a QuickPay operation 215. QuickPay operation 215 is a one-click payment that allows user 102 to pay from the login screen using default payment information such as funding source and shipping address. Quick Pay operation 215 may be provided as a default operation, or it may be selected by the user by clicking its appropriate box, for example, as illustrated by a checkmark therein. When QuickPay operation 215 is executed, payment is completed as illustrated in block 218.

Alternatively, in block 216, user 102 may review the purchase details before completing payment and may decide to change, for example, payment arrangements such as funding source and/or shipping address. For example, user 102 may choose a specific credit card as a funding source. Once user 102 has reviewed and agreed to the purchase details, user 102 completes payment and the transaction is finalized as illustrated in block 218.

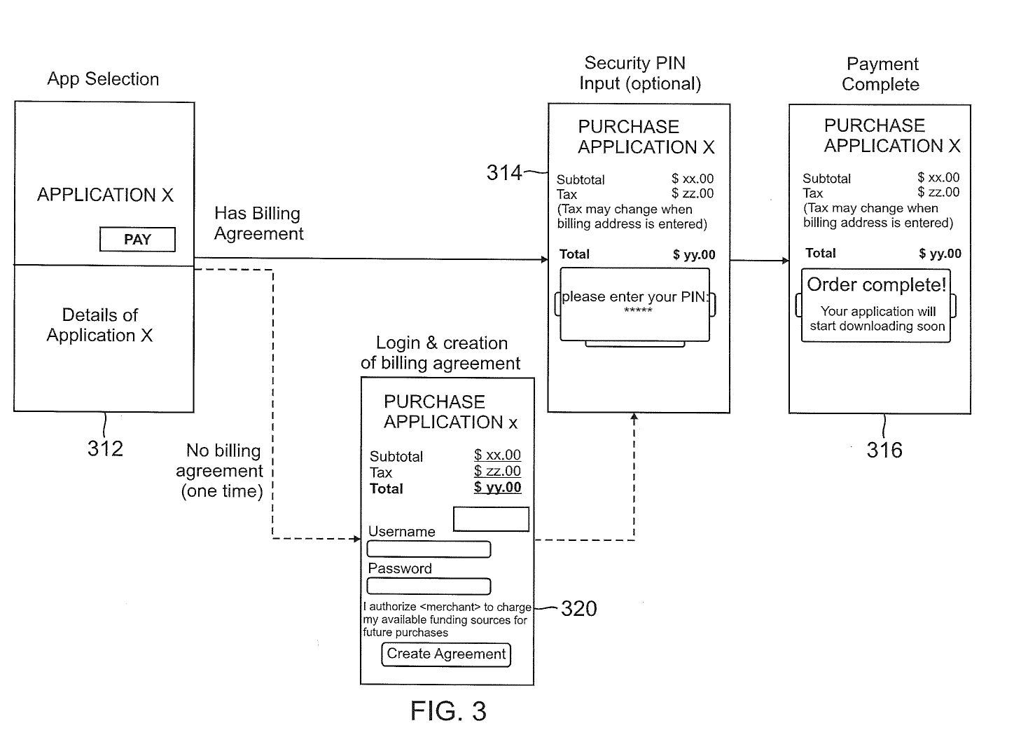

Referring now to FIG. 3, a block diagram for a billing agreement is illustrated according to an embodiment of the present disclosure.

In a billing agreement, user 102 (referring also to FIG. 1) pre-authorizes merchant server 140 (or a partner that processes transactions on behalf of merchant(s)) to charge the available funding sources on the user's service provider account with variable amounts every time user 102 makes a purchase (without the need to login to authorize each charge). A user is then able to quickly pay for future purchases without login into service provider server 180. In addition, user 102 is able to change his or her default payment information, for example, a preferred funding source to be used for future purchases (subject to, for example, funding logic implemented by service provider server 180).

There may be various scenarios that may arise when using a billing agreement established by user 102 with merchant server 140 (or partner).

In block 312, user 102 may select to pay for an application, product and/or service using a billing agreement that has been previously created. In the embodiment of FIG. 3, user 102 may browse merchant server 140 and decide to purchase an application, product and/or service, such as an Application X as illustrated therein. User 102 may decide to use a billing agreement set up through service provider server 180 to pay for the selected application, produce and/or service.

In block 314, if user 102 has an existing billing agreement with a merchant server 140 (or partner), user 102 may be required to input a PIN or other authentication information or credential before completing payment in block 316.

Alternatively, in block 320, if user 102 has an account with service provider server 180, but does not have a billing agreement set up with a merchant (or partner), user 102 may login and create a billing agreement with the merchant (or partner) using client device 120. It should be noted that a billing agreement may also be created between a user and a merchant (or partner) via other ways, for example, by executing a separate online agreement or a hard copy agreement. Under the billing agreement, user 102 authorizes a merchant server 140 (or partner) to charge the user's available funding sources for future purchases. Once a billing agreement is established, user 102 may be required to input a PIN or other authentication information as illustrated in block 314 before completing payment for the selected application as illustrated in block 316.

In another aspect according to an embodiment, user 102 has the option of setting up an arrangement with a merchant server 140 (or partner) for subscription/recurring payments via a subscription/recurring agreement similar to the billing agreement described above with respect to the embodiment of FIG. 3. A subscription/recurring agreement allows a user to pre-authorize a merchant (or partner that processes transactions on behalf of merchant(s)) to charge the available funding source(s) on the user's service provider account with constant amounts in pre-defined frequency (monthly, weekly etc.), without the need to login to authorize each charge. For subscription/recurring arrangement payments, once the user's initial authorization on client device 120 is accepted, the user's service provider account on service provider server 180 may be automatically debited in predefined periods. In addition, user 102 is able to change his or her default payment information, for example, a preferred funding source to be used for subscription/recurring payments (subject to, for example, funding logic implemented by service provider server 180).

Payments made by user 102 for a selected application, product and/or service may be split between one or more parties or receivers according to one or more embodiments described below.

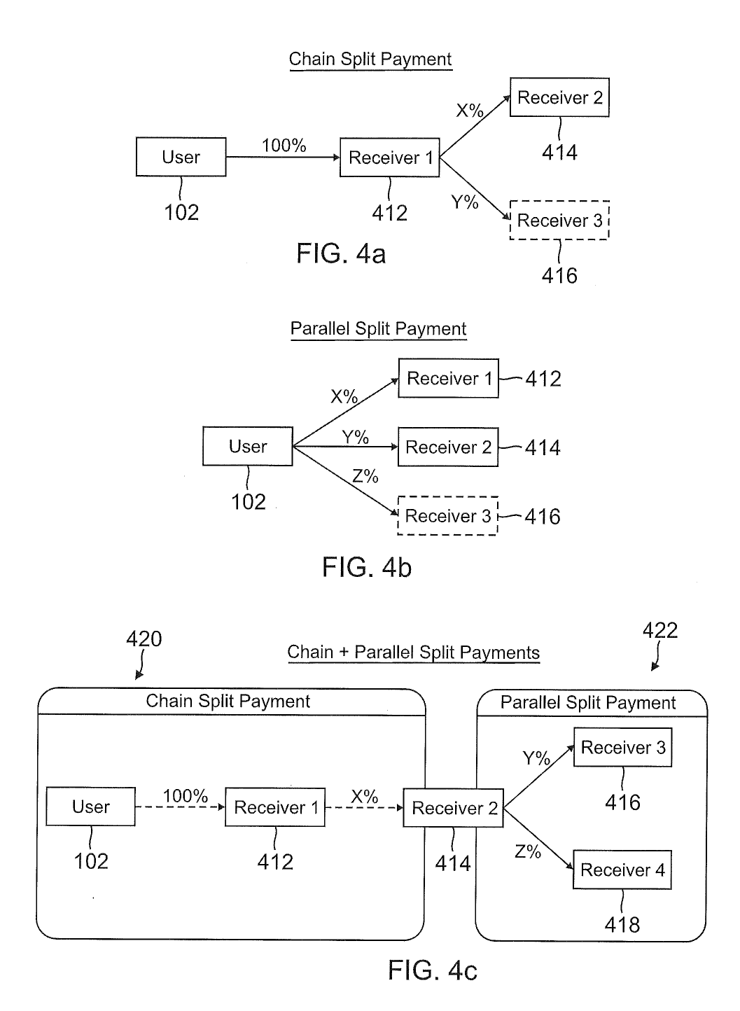

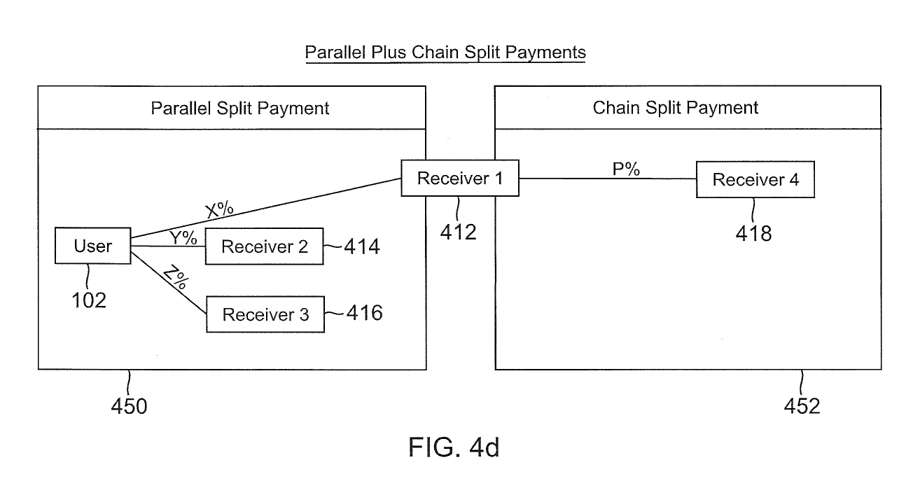

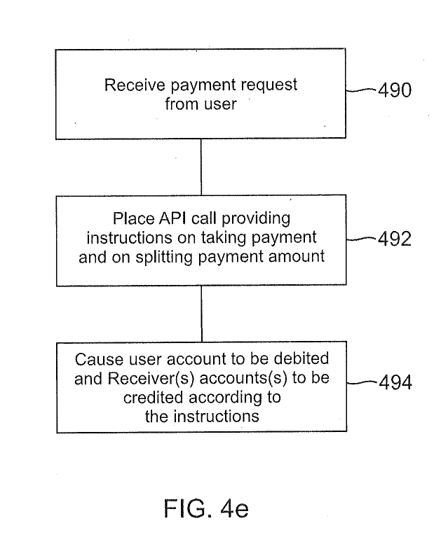

Referring now to FIGS. 4a, 4b, 4c and 4d, flow diagrams for split payment options are illustrated according to one or more embodiments of the present disclosure. FIG. 4a is a flow diagram illustrating a chain split payment option system according to an embodiment. FIG. 4b is a flow diagram illustrating a parallel split payment option system according to an embodiment. FIG. 4c is a flow diagram illustrating a chain plus parallel split payment option system according to an embodiment. FIG. 4d is a flow diagram illustrating a parallel plus chain split payment option system according to an embodiment.

Split payments according to one or more embodiments described herein may be made to one or more parties or receivers (which may include entities such as a merchant, partner, marketplace, etc.) in different ways to accommodate various situations including, for example, use cases of commissions, revenue share marketplace, etc. One specific example of the use of split payments may involve making a payment to a receiver such as a legal entity for a real estate matter wherein the legal entity would in turn have payment obligations to other receivers such as a title company, an inspector, an agent, etc., which may or may not interact directly with the user.

An API call, for example, may be placed by an appropriate calling party including a merchant, a marketplace or application operator, a client device manufacturer, a carrier, etc., to provide instructions on how to split a payment amount between one or more parties or receivers to effectuate the payment. Once the API call providing payment instructions is made, the user's account is debited and the one or more receivers are paid accordingly.

In the chain split payment system of the embodiment of FIG. 4a, when user 102 (referring also to FIG. 1) submits a payment amount for a selected application, product and/or service to a merchant server 140 (or partner), for example, through a one-time payment, a billing agreement or a subscription/recurring agreement, the payment amount may be split between different receivers in sequential (or chain) order.

Embodiments of a chain split payment system may apply to situations wherein a merchant server 140 (or partner) shares part of the payment amount with other players, for example, in a marketplace wherein the merchant server 140 (or partner) posts items that belong to other parties, or in other cases, for example, wherein the payment is to be split between several receivers, for example, a merchant, the developer of the application, product and/or service, and a service provider. A specific example for use of a chain split payment system includes commission payments wherein, for example, a business entity pays employees a commission payment based on sales completed. The user may not have full visibility into this type of chain split payment transactions.

In the embodiment of FIG. 4a, the payment amount received from user 102 over a client device for a selected application, product and/or service may be split between different receivers sequentially, that is, in an embodiment, 100% of the payment amount may first go to Receiver 1 in block 412, then the payment amount may be split in applicable percentages between Receiver 2 in block 414 and Receiver 3 in block 416. Receiver 2 in block 414 may get X % of the payment amount and Receiver 3 in block 416 may receive Y % of the payment amount.

In operation, an API call, for example, may be placed by an appropriate calling party, which may include a merchant, a marketplace or application operator, a client device manufacturer, a carrier, or the like, to provide payment instructions to split the payment amount and effectuate payment accordingly. For example, the calling party may make an API call providing payment instructions to service provider server 180, including to: 1) post full payment amount to Receiver 1 in block 412, 2) take all or part of the payment amount from Receiver 1 and post it to Receiver 2 in block 414, Receiver 3 in block 416, and/or other Receivers as may be appropriate. Optionally, additional instructions may be included, for example, on how to allocate service provider server fees to the Receivers, such as whether to take service provider server fees from each Receiver, or only from one or some of the Receivers.

The operation described above results in user 102 seeing a debit of full payment amount on his or her service provider server 180 account. Receiver 1 in block 412 sees a credit of full payment amount in his service provider server 180 account and a debit of the amount to be sent to other receiver(s) such as Receiver 2 in block 414 and/or Receiver 3 in block 416. Receiver 2 in block 414, Receiver 3 in block 416 and/or other Receivers see a credit of appropriate amounts in their service provider server 180 accounts. Fees for service provider server 180 may be taken from appropriate Receivers as reflected in, for example, the API call.

FIG. 4b illustrates a block diagram of a parallel split payment system according to an embodiment. A payment amount (submitted by user 102 through a one-time payment, a billing agreement payment or a subscription/recurring agreement payment) may be taken and split between different receivers in parallel order. This embodiment may apply to situations when a merchant server 140 (or partner) shares part of the payment amount with other parties, for example, in a marketplace wherein a merchant server 140 (or partner) posts items that belong to other parties. A specific example for use of a parallel split payment system includes situations where two or more simultaneous business relationships take place such as travel transactions. For example, a payment amount may be split in parallel to pay for a travel agent, hotel accommodations and/or airplane tickets. The user may have full or partial visibility into this type of parallel split payment transactions.

In FIG. 4b, a payment amount may be split between different Receivers in parallel (Receiver 1 in block 412, Receiver 2 in block 414, Receiver 3 in block 416, and/or other Receivers as appropriate). The same or different percentages of the payment amount may be allocated to each Receiver, for example, Receiver 1 in block 412 may be allocated X % of the payment amount, Receiver 2 in block 414 may be allocated Y % of the payment amount, Receiver 3 in block 416 may be allocated Z % of the payment amount, etc.

In operation, an API call, for example, may be placed by an appropriate calling party, which may include a merchant, a marketplace or application operator, a client device manufacturer, a carrier, or the like, to provide payment instructions to split the payment amount and effectuate payment accordingly. For example, the calling party may make an API call providing payment instructions to service provider server 180, including to split the payment amount between different Receivers in parallel. Optionally, additional instructions may be included, for example, on whether to take service provider server fees from each Receiver, or only from one or some of the Receivers.

The operation described above with respect to the embodiment of FIG. 4b results in user 102 seeing a debit of the full payment amount on his or her service provider server 180 account. Receiver 1 in block 412, Receiver 2 in block 414, Receiver 3 in block 416 and/or other Receivers see a credit of appropriate amounts in their service provider server 180 accounts. Fees for service provider server 180 may be taken from appropriate Receivers as reflected in the API call.

FIG. 4c illustrates a chain plus parallel split payment system according to an embodiment. A payment amount (submitted through a one-time payment, a billing agreement payment or a subscription/recurring agreement payment) may be split between different receivers first in a chain split payment system 420 and then in a parallel split payment system 422 to be described herein. This embodiment may apply to situations wherein a merchant server 140 (or partner) shares part of the payment amount with other parties, for example, in a marketplace wherein a merchant/partner posts items that belong to other parties.

A payment amount may be split between different Receivers first in a chain split payment system 420 (Receiver 1 in block 412, then Receiver 2 in block 414) and then in a parallel split payment system 422 (Receiver 3 in block 416, Receiver 4 in block 418, and/or other Receivers as may be appropriate.). Appropriate percentages of the payment amount may be allocated to each Receiver. In chain split payment system 420, 100% of the payment amount may first go to Receiver 1 in block 412, then the payment amount may be split in applicable percentages between Receiver 2 in block 414 and Receivers in parallel split payment system 422 including Receiver 3 in block 416 and Receiver 4 in block 418. Receiver 2 in block 414 may receive X % of the payment amount. Receiver 3 in block 416 may receive Y % of the payment amount and Receiver 4 in block 418 may receive Z % of the payment amount.

In operation, an API call, for example, may be placed by an appropriate calling party, which may include a merchant, a marketplace or application operator, a client device manufacturer, a carrier, or the like, to provide payment instructions to split a payment amount between different receivers first in chain (or sequential) order and then in parallel order, and effectuate payment accordingly.

For example, in chain split payment system 420, the calling party may make an API call providing payment instructions to service provider server 180, including to first post full payment to Receiver 1 in block 412, then all or part of the payment amount from Receiver 1 in block 412 may be taken and posted to Receiver 2 in block 414 and/or other Receivers in appropriate percentages. Optionally, additional instructions may be included, for example, on whether to take service provider server fees from each Receiver, or only from one or some of the Receivers.

The operation described above results in user 102 seeing a debit of full payment amount on his or her service provider server 180 account. Receiver 1 in block 412 sees a credit of full payment amount in his service provider server 180 account and a debit of the amount to be sent to other receiver(s) such as Receiver 2 in block 414 and/or other Receivers. Receiver 2 in block 414 and/or other Receivers see a credit of appropriate amounts in their service provider server 180 accounts. Fees for service provider server 180 may be taken from appropriate Receivers as reflected in the API call.

In parallel split payment system 422, for example, the payment instructions to service provider server 180 include to split the payment amount between different Receivers, including, for example, Receiver 3 in block 416 and Receiver 4 in block 418.

The operation described above results in Receiver 2 in block 414 seeing a debit of appropriate payment amounts in his or her service provider server 180 account to be sent to other Receivers such as Receiver 3 in block 416 and Receiver 4 in block 418. Receiver 3 in block 416, Receiver 4 in block 418 and/or other Receivers see a credit of appropriate payment amounts in their service provider server 180 accounts. Fees for service provider server 180 may be taken from appropriate Receivers as reflected in the API call.

FIG. 4d illustrates a parallel plus chain split payment system according to an embodiment. A payment amount (submitted by user 102 through a one-time payment, a billing agreement payment or a subscription/recurring agreement payment) may be split between different receivers first in a parallel split system 450 and then in a chain split system 452 to be described herein. This embodiment may apply to situations wherein a merchant server 140 (or partner) shares part of the payment amount with other parties, for example, in a marketplace wherein a merchant/partner posts items that belong to other parties.

A payment amount may be split between different Receivers first in a parallel split payment system 450 (Receiver 1 in block 412, Receiver 2 in block 414 and Receiver 3 in block 416) and then in a chain split payment system 452 (Receiver 4 in block 418 and other Receivers as may be applicable). Appropriate percentages of the payment amount may be allocated to each Receiver. In parallel split payment system 450, X % of the payment amount may go to Receiver 1 in block 412, Y % of the payment amount may go to Receiver 2 in block 414 and Z % of the payment amount may go to Receiver 3 in block 416. Next, the payment amount may be split in applicable percentages between Receiver 1 in block 412 and Receivers in chain split payment system 452 including Receiver 4 in block 418. Receiver 4 in block 418 may receive P % of the payment amount.

In operation, an API call, for example, may be placed by an appropriate calling party, which may include a merchant, a marketplace or application operator, a client device manufacturer, a carrier, or the like, to provide payment instructions to split a payment amount between different receivers first in parallel order and then in chain (or sequential) order, and effectuate payment accordingly.

For example, in parallel split payment system 450, the calling party may make an API call providing payment instructions to service provider server 180, including to post payment to Receiver 1 in block 412 for X % of the payment amount, Receiver 2 in block 414 for Y % of the payment amount, and Receiver 3 in block 416 for Z % of the payment amount. Next, all or part of the payment amount, for example, from Receiver 1 in block 412 may be taken and posted to Receiver 4 in block 418 and/or other Receivers in appropriate percentages in chain split payment system 452. Optionally, additional instructions may be included, for example, on whether to take service provider server fees from each Receiver, or only from one or some of the Receivers.

The operation described above results in user 102 seeing a debit of full payment amount on his or her service provider server 180 account. Receiver 1 in block 412 sees a credit of X % of the payment amount in his service provider server 180 account and a debit of the amount to be sent to other receiver(s) such as P % to Receiver 4 in block 418 and/or other Receivers. Receiver 2 in block 414, Receiver 3 in block 416 and/or other Receivers see a credit of appropriate amounts in their service provider server 180 accounts. Fees for service provider server 180 may be taken from appropriate Receivers as reflected in the API call.

In operation, in chain split payment system 452, for example, the payment instructions to service provider service server 180 include to split the payment amount of, for example, Receiver 1 in block 412 to be posted to Receiver 4 in block 418 in an appropriate percentage P %.

The operation described above with respect to chain split payment system 452 results in Receiver 1 in block 412 seeing a debit of appropriate payment amounts in his or her service provider server 180 account to be sent to other Receivers such as Receiver 4 in block 418 and/or other Receivers as may be applicable. Receiver 4 in block 418 and/or other Receivers see a credit of appropriate payment amounts in their service provider server 180 accounts. Fees for service provider server 180 may be taken from appropriate Receivers as reflected in the API call.

It should be noted that in the payment system options described above with respect to the embodiments of FIGS. 4a-4d, the number of Receivers involved as well as the percentages credited or debited to each Receiver are for illustration purposes only, and may vary according to instructions, for example, in the API call. Also, it should be noted that the split payment systems described above with respect to the embodiments of FIGS. 4a-4d may be combined so that various permutations of split payment systems may be achieved according to one or more embodiments of the present disclosure.

Referring to FIG. 4e, a flow chart for effectuating payment instructions is illustrated according to an embodiment of the present disclosure.

In block 490, a payment request is received for paying for an application, product and/or service selected by a user over a client device. As described above, a user may purchase and pay for a selected application, product and/or service over the client device using various payment options including, for example, a one-time payment, a billing agreement or a subscription/recurring agreement.

In block 492, an API call may be placed by a calling party, which may include a merchant, a marketplace or application operator, a client device manufacturer, a carrier, or the like, to provide payment instructions to, for example a payment service provider, on how to split a payment amount between one or more parties or receivers and effectuate payment accordingly. As described above according to one or more embodiments, a payment amount may be split in chain (or sequential) order, in parallel order or in any permutation combining one or more of a chain order and a parallel order.

In block 494, to effectuate appropriate payment, the payment service provider, for example, may be caused to debit the user's account with the payment service provider and to credit each receiver's account with the payment service provider according to the payment instructions received in the API call.

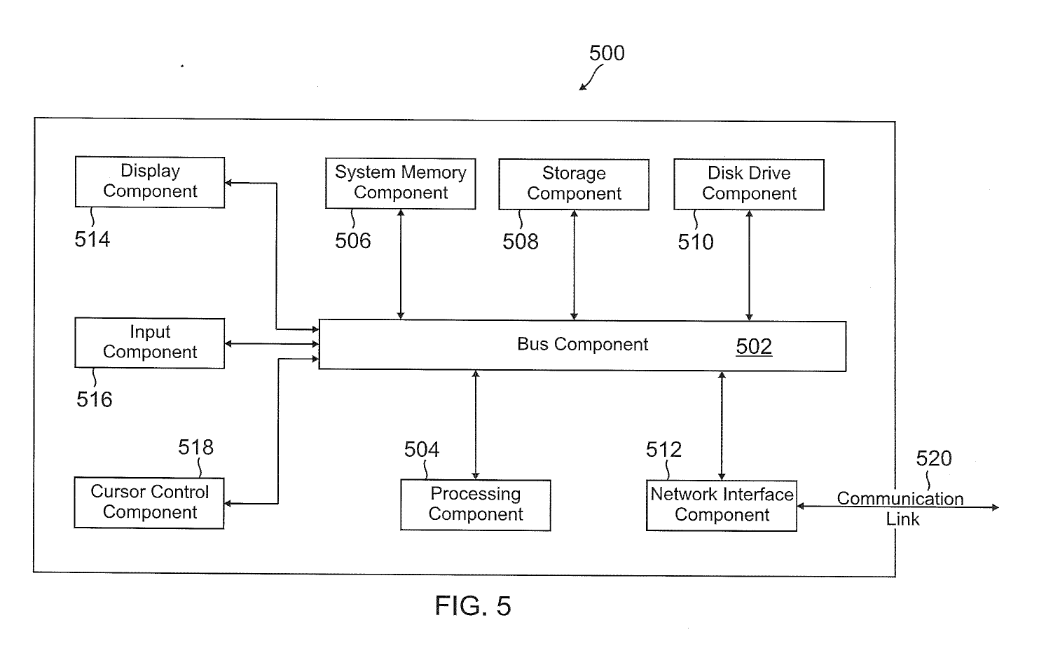

FIG. 5 is a block diagram of a system 500 suitable for implementing embodiments of the present disclosure, including client device 120, one or more merchant servers or devices 140, and service provider server or device 180. System 500, such as part of a cell phone, personal computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to process financial transactions, make payments, split payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for payments or financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., network 160 of FIG. 1, LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

In view of the present disclosure, it will be appreciated that various methods and systems have been described according to one or more embodiments for facilitating payment options in financial transactions over a client device with minimal key entries.

Although various components and steps have been described herein as being associated with client device 120, merchant server 140, and payment service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

What is claimed is:

1. A payment method comprising:
receiving, by a payment provider, a payment amount for an application, product and/or service selected by a user over a client device, wherein the payment amount is split between one or more receivers according to instructions provided for splitting the payment amount; and
transferring the payment amount to one or more accounts among the one or more receivers according to the instructions.

2. The method of claim 1 wherein the instructions are provided via an API call.

3. The method of claim 1, wherein the user selects to pay the payment amount over the client device according to a one-time payment, a billing agreement or a subscription/recurring agreement.

4. The method of claim 1 wherein a user's account is debited and accounts of the one or more receivers are credited in predetermined percentages according to the instructions.

5. The method of claim 1 wherein the instructions further comprise allocating service provider server fees to the one or more receivers.

6. The method of claim 1, wherein the payment amount is split between the one or more receivers in a sequential order.

7. The method of claim 6, wherein the payment amount is split so that 100% of the payment amount is allocated to a first receiver and then the payment amount is split in applicable percentages between one or more other receiver(s).

8. The method of claim 7, wherein a full payment amount is debited to a user's service provider account; the full payment amount is credited and an appropriate amount to be sent to the one or more other receiver(s) is debited to a service provider account of the first receiver; and wherein the appropriate amount is credited to a service provider account of the one or more other receiver(s).

9. The method of claim 1, wherein the payment amount is split between the one or more receivers in a parallel order.

10. The method of claim 9, wherein the payment amount is split so that the same or different percentages of the payment amount is allocated to each of the one or more receivers.

11. The method of claim 10, wherein
a full payment amount is debited to a user's service provider account; and
an appropriate amount is credited to a service provider account of each receiver.

12. The method of claim 1, wherein the payment amount is split between different receivers first in a chain split payment and then in a parallel split payment order.

13. The method of claim 12, wherein the payment amount is split in appropriate percentages and the appropriate percentages of the payment amount are allocated to each one of the different receivers.

14. The method of claim 1, wherein the payment amount is split between different receivers first in a parallel split payment and then in a chain split payment order.

15. The method of claim 14, wherein the payment amount is split in appropriate percentages and the appropriate percentages of the payment amount are allocated to each one of the different receivers.

16. A client device comprising:
a payment application loaded in the client device from a service provider server;
one or more processors; and
one or more memories adapted to store a plurality of machine-readable instructions which when executed by the one or more processors are adapted to cause the client device to:
cause the service provider server to receive a payment amount for a selected application, product and/or service over a network, wherein the payment amount is split between one or more receivers according to instructions provided to the service provider server; and wherein
the payment amount is transferred, by the service provider server, to one or more accounts among the one or more receivers according to the instructions.

17. The client device of claim 16, wherein the machine-readable instructions when executed by the one or more processors are adapted to submit the payment amount for the selected application, product and/or service according to a one-time payment option, a billing agreement or a subscription/recurring agreement.

18. The client device of claim 17, wherein the one-time payment option further comprises a quick pay operation provided as a default operation.

19. The client device of claim 17, wherein the one-time payment option further comprises a quick pay operation selectable by a user.

20. The client device of claim 16, wherein the machine-readable instructions when executed by the one or more processors are adapted to cause the client device to pass a user identifier with payment information to the service provider server.

21. The client device of claim 16 further comprising a wireless telephone, a personal digital assistant (PDA), a personal computer, or a notebook computer.

22. The client device of claim 16 further comprising a television set, a game console, a DVR, a microwave, a refrigerator or a washing machine.

23. A payment system comprising:
a client device adapted to communicate with a payment service provider over a network;
one or more processors; and
one or more memories adapted to store a plurality of machine-readable instructions which when executed by the one or more processors are adapted to cause the payment system to:
receive, by the payment service provider, a payment for an application, product and/or service selected by a user over the client device, wherein the payment is split between one or more receivers according to instructions provided to the payment service provider over the network, causing a user's payment service provider account to be debited and causing each of the one or more receivers' payment service provider account(s) to be credited according to the instructions.

24. The payment system of claim 23 wherein the payment is split between the one or more receivers in a sequential order, a parallel order, a chain plus parallel order or a parallel plus chain order.

25. The payment system of claim 23 wherein the instructions are provided via an API call.
